(19) United States
(12) Patent Application Publication
(10) Pub. No.: US 2024/0426768 A1
(43) Pub. Date: Dec. 26, 2024

(54) METHOD FOR INSPECTING A TANK, SLUICE DEVICE AND ARRANGEMENT COMPRISING A TANK, A SLUICE DEVICE AND AN INSPECTION DEVICE

(71) Applicant: Rosen IP AG, Stans (CH)

(72) Inventors: Matthias Grote, Lingen (DE); Berry Krijbolder, HB Zoetermeer (NL)

(21) Appl. No.: 18/682,495

(22) PCT Filed: Aug. 15, 2022
(86) PCT No.: PCT/EP2022/072789

§ 371 Date: Feb. 9, 2024

(30) Foreign Application Priority Data
Aug. 13, 2021 (BE) BE2021/5647

(51) Int. Cl. G01N 21/954

(52) U.S. Cl. CPC G01N 21/954

(57) ABSTRACT

A method is provided for inspecting a tank for fluid media with an inspection device which records measurement data inside the tank on a base, a wall and/or any upper boundary of the tank. The inspection device is introduced into the tank through an access opening from a sluice chamber of a sluice device which is pre-connected to the tank through a sluice entrance after the access opening has been opened. The inspection device is adapted to the conditions present in the tank, and is transferred back into the sluice device after the measurement data have been recorded.

### CROSS REFERENCE

This application claims priority to PCT Application No. PCT/EP2022/072789, filed Aug. 15, 2022, which itself claims priority to Belgian Patent Application No. BE2021/5647, filed Aug. 13, 2021, the entireties of both of which are hereby incorporated by reference.

### FIELD OF THE INVENTION

The present invention relates to a method for inspecting a tank for fluid media, preferably for flammable and/or explosive energy carriers, in particular for inspecting a fixed-roof or floating-roof tank, with an inspection appliance that records measurement data on the inside of the tank on a floor, a wall and/or any upper delimitation of the tank that is present and preferably realized as a fixed or floating roof, wherein the inspection appliance is inserted into the tank through an access opening. Furthermore, the invention relates to a sluice device comprising a sluice chamber and a sluice access. In addition, the invention relates to an arrangement comprising a tank, a sluice device and an inspection appliance.

### BACKGROUND OF THE INVENTION

In many storage facilities for explosive or flammable fluid energy sources, for example in the form of crude oil, these are stored in large tanks that are often realized as floating-roof or fixed-roof tanks. For the purpose of the invention, the tanks also include large spherical or cigar-shaped pressurized containers, which in particular store gaseous carriers and which must be inspected, as well as open-top water storage tanks. Irrespective of which regions of a gas tank, for example a cigar-shaped gas tank, are designated as a floor, wall or upper delimitation, or roof or ceiling, these have metallic sides or walls that need to be inspected. Typical sizes for the tanks to be inspected range from a few cubic meters to several thousand cubic meters.

In order to be inserted into a tank for energy carriers, an inspection appliance must be ATEX-certified. The inspection appliance is typically inserted into the tank via access openings arranged on the roof, in particular a floating roof of a tank. Due to the ambient oxygen, the inspection appliance and the associated maintenance personnel are in an explosion-hazard zone. The inspection is correspondingly hazardous and, due to the necessary ATEX certification, is complex.

### BRIEF SUMMARY OF THE INVENTION

It is an object of the present invention to improve the inspection of a tank for energy carriers in such a way that the explosion hazard is reduced and the method can also be used for other tanks.

A method according to the invention is characterized in that, after the access opening has been opened, the inspection appliance is inserted into the tank through a sluice access from a sluice chamber, adapted to the conditions present in the tank, of an in particular mobile sluice device, connected in advance to the tank. After the measurement data has been recorded, the inspection appliance is transferred back into the sluice device, whereupon, in particular, the access opening is closed. Due to the sluice device, or the sluice chamber, being adapted to the conditions present in the tank, the inspection appliance being already arranged in the sluice chamber, the inspection appliance is no longer in an ATEX explosion-hazard zone when inserted into the tank, or the ATEX requirements are reduced, such that a complex ATEX certification of the inspection appliance is no longer necessary or is simplified. In this way, other large tanks, for example water tanks, can also be inspected during operation, i.e. in the filled state.

The inspection appliance may be transferred into the tank either autonomously or non-autonomously, i.e. controlled by a remote control, and record its measurement data there. This makes the inspection process much less hazardous for the operating personnel. Adaptation to the conditions present in the tank is understood as a process that, in dependence on the medium present in the tank, produces the same or similar conditions in the sluice chamber, for example fills it with the same medium and/or builds up a corresponding pressure.

In particular, an explosion hazard is reduced by the adaptation to the conditions present in the tank. This includes, in particular, at least reducing the oxygen present in the sluice chamber to concentrations that are not hazardous for opening the tank. The concentration depends on the medium. In particular, the oxygen present in the sluice chamber is removed. The sluice chamber can therefore also be put under negative pressure for the purpose of adaptation to the conditions prevailing in the tank, irrespective o of the pressure prevailing there. Alternatively or additionally, any ambient air present in the sluice chamber is replaced by a protective gas, such that the explosion hazard is reduced when the chamber is opened.

The sluice device is connected to the tank in advance. This may be effected at the factory during production of the tank or subsequently. The sluice device may be permanently installed on the tank and remain there after the inspection process until the next inspection process. Preferably, it is a mobile device that is connected to the tank, in particular by means of a quick-release fixing. Examples of a quick-release fixing are a bayonet fixing and/or fixings that have a tensioning device, for example in the form of a tension chain or at least a tension clip.

The measurement data are transmitted to an associated control device while the measurement is still in progress or afterwards and can then be analyzed in respect of the condition of the tank, in particular with regard to corrosion and/or other defects.

The sluice device is preferably of mobile design, so that, once the inspection process is complete, when the inspection appliance is back in the sluice chamber and the tank is closed again, it is moved and/or travels to the next tank. For this purpose, the device may move independently or be carried, for example by means of a crane or other mobile lifting device. The sluice access is realized by an opening of the sluice chamber to be arranged towards the access opening. For arrangement on a crane or other lifting device, the sluice device has appropriate fastening means, for example hooks, eyelets or prong receivers.

Preferably, for the purpose of adaptation to the conditions present in the tank, the sluice chamber is filled with the medium stored in the tank before the access opening is opened, and in particular the medium previously present in the sluice chamber is displaced. This may be effected via a pump system, assigned to the sluice device, that can also be connected to the tank, or is effected purely passively by opening of the access opening and any existing vent valves or vent openings, causing a medium present in the tank to displace the medium previously present in the sluice chamber. In particular, the medium arranged in the sluice chamber may be an inert gas that has preferably been flooded in advance into the sluice chamber from a corresponding storage device and that will not result in an ATEX classification.

For better verification of the adaptation to the conditions present in the tank and/or for monitoring the sluice chamber, data from at least one sensor arrangement may be acquired and, in particular, compared automatically. The sensor arrangement of the sluice device according to the invention has at least one pressure sensor and/or one media sensor. In particular, it is designed for sensing the pressure conditions in the sluice chamber. Alternatively or additionally, it may sense the conditions in the transition to the tank, i.e. in particular upstream of a sluice closure device leading to the tank. With a plurality of sensors, different conditions can also be sensed by one or more regions of the sluice device. The adaptation of the sluice chamber may also be effected on the basis of an in particular automated comparison of the data, in which case, for example, data from the transition to the tank upstream of a sluice closure device and downstream thereof, i.e. on the sluice chamber side, are compared with each other. The sensor arrangement may also have means for displaying the values. The sensor arrangement may be integrated into a control device of the sluice device.

In particular, for the purpose of adaptation to the conditions present in the tank, one or more valves are controlled by means of a control device of the sluice device according to the invention. The operating of the valve or valves may be effected, in particular, automatically on the basis of the data from the sensor arrangement, such that the adaptation of the sluice chamber or its emptying of the medium can be controlled and monitored by means of the control device. The control device may also have a human-machine interface.

Alternatively or additionally, the sluice chamber may also be emptied purely passively, in that a preferably inert gas is preferably introduced in an upper region at a pressure that exceeds that of the medium in the tank, displacing the tank medium from the sluice chamber. The drain connections in this case are preferably located in the base region of the sluice chamber.

In particular, the sluice device is of a mobile design, such that, following the inspection of a first tank, it can be connected to a second tank. Preferably, if the media in the tanks to be inspected are identical, the sluice chamber of the sluice device is filled with the medium of the first tank when the sluice device is transferred to the second tank, which saves a considerable amount of time as the medium does not have to be emptied from the sluice device.

Particularly in the case of a mobile sluice device, it is advantageous if the sluice device, which has a sealing arrangement on at least one side, is initially arranged close to the tank, at least on the outside, in such a way that the access opening can be reached from the sluice chamber without any medium from the tank being able to escape into the environment. Accordingly, the sluice device may be arranged, for example, on a closable valve, or valve flange, of the tank, which may have been installed on the tank in advance and which also forms the access opening, and which corresponds to a corresponding flange device of the sluice device. Alternatively or additionally, the sluice device may be arranged not only on the outside, but also so as to partially engage in a corresponding access opening. This can be advantageous it that it simplifies the transfer of the inspection appliance into the tank. For the purpose of adaptation to different tanks, or their access openings, the flange device of the sluice device may be arranged in a detachable, and thus interchangeable, manner on the further sluice device.

In order to simplify inspection of the tank, the sluice device, which can be closed by means of at least one sluice closure device, is preferably arranged at an in particular lateral access opening of the tank. An access opening is understood here to be an opening in the tank that can preferably be closed by means of a valve and that, in particular, is also sufficiently large for human access. It is at least 20 to 36 inches in size, however, such that an inspection appliance can enter the tank through it. In the case of a lateral arrangement, there is no need for the sluice device to be arranged, for example, on a floating roof. In the case of permanently installed sluice devices, the sluice device may also have a sluice closure device by which the sluice chamber can be isolated from the tank. In the case of mobile sluice devices, a sluice closure device may close the sluice chamber on a side that faces toward the access opening and thus form a barrier to the tank interior. Alternatively or additionally, there may be a sluice closure device arranged on a further side of the sluice device to allow access to the sluice chamber when the sluice device is arranged on the tank.

Advantageously, access to the tank is effected by means of a sluice device operating from the ground.

Preferably, the inspection appliance is inserted into the sluice device in advance and/or removed subsequently, i.e. it may be already arranged in the sluice device when the latter is attached to the access opening of the tank. If the sluice device has a further sluice access arranged, for example, at the other end of the sluice device and opposite the sluice access that faces toward the tank, the inspection appliance can also be inserted into the sluice device subsequently. It is understood that the opening of at least this further sluice access can be closed by means of a sluice closure device.

In particular, the inspection appliance may be transferred from the sluice chamber, through the access opening, into the tank by means of a carrying and/or supporting device of the sluice device, the inspection appliance being set down in the tank, in particular by means of a telescopic part that moves into the tank. This telescopic part may have, for example, a holding or hook receiver on which the inspection appliance is held. The telescopic part may also provide, for example, an electric power supply and/or a cabled connection to the inspection appliance via this holder. For example, the sluice device is provided with a cable reel, the cable being guided via corresponding guide means of the carrying and/or supporting device. Alternatively or additionally, the cable may also be pulled behind the inspection appliance during the inspection, with monitoring of a particular cable tension, and wind itself up again when the inspection appliance approaches the pick-up and removal point. The carrying and/or supporting device may also comprise a ramp that can be extended into the tank and via which the inspection appliance can be moved into and out of the tank.

A particularly flexible handling of the sluice device is furthermore provided in particular if, for the purpose of arranging the sluice device at the access opening, the sluice device is adjusted, by means of a height adjustment device, with respect to the height of the part to be connected to the access opening above the ground.

According to the invention, the sluice device in this case may be provided with an extendable chassis and/or frame that has, for example, telescopic supports on which wheels are mounted for moving the sluice device and via which the sluice body comprising the sluice chamber is supported in relation to the ground. In the case of non-movable variants, these may be telescopic supports. In addition, the sluice device may be lifted by crane or forklift truck to the appropriate height for arranging it on the tank.

For the purpose of checking the inspection appliance, the sluice device may have a viewing window, alternatively or additionally at least one camera, such that the inspection appliance is checked by means of at least one camera and/or by means of at least one viewing window. At least a visual inspection of the inspection appliance in the sluice device can be effected. Having a camera arranged on the inspection appliance itself and/or on a part of the sluice device that can be moved into the tank allows improved checking during the actual inspection.

Preferably, the sluice device can be moved to the place of use by means of its own drive system, and may be moved accordingly by an operator. For this purpose, the drive system has corresponding motor means, as well as energy storage in the form of battery and/or fuel storage units. Depending on the design, the sluice device, which is self-propelled by means of its own drive system, comprises in particular a chassis (of the drive system), the chassis having at least one drivable drive element. In particular, the drive element is a wheel, for example for travel on a road-like or flat surface or a flanged wheel for travel on rails. A chain drive is also possible. The one or more drive elements may each be provided with their own motor, for example in the manner of a wheel hub motor. Moreover, the driven wheels in particular are provided with an encoder for recognizing the wheel position in the circumferential direction, or direction of rotation. Alternatively or additionally, a drive element preferably has a transmission for transmitting the torque generated by the drive.

Preferably, the sluice device comprises a wireless or cable-connected remote control, such that the entire sluice device that can be moved by its own drive elements, i.e. independently, can be moved under the control of the operating personnel. The operating personnel can then accompany the procedure directly on foot, with the sluice device travelling at walking speed of up to a maximum of 15 km/h. The remote control may be a remote control equipped with one or more joysticks or toggle buttons for operating the drive elements, or an associated controller. For wireless communication between the remote control and the rest of the sluice device, both have corresponding radio interfaces.

As an alternative or in addition to a sluice device that can be moved, or moves, independently with a remote control, the sluice device may also move autonomously, preferably when prompted by means of an internal or external control command. For this purpose, the sluice device may be equipped with one or more environment sensors to perceive the environment around the sluice device. Alternatively or additionally, the sluice device may be equipped with a system for determining the geo-position, in particular based on a satellite system, for example GPS, Galileo or similar. The data collected via the environment sensors are collected in a data processing unit, in particular a computer unit of the sluice device, and analyzed with the aim of moving the sluice device to a new position. The environment sensors can be used to recognize and avoid obstacles. The environment sensor or sensors is (are), for example, lidar, IR, radar and/or ultrasonic sensors. Cameras operating in the visible light range may be used as an alternative or in addition to the sensors mentioned above. It is understood that the individual sensor types may be combined.

For the installation and inspection process, it is advantageous if the sluice device has at least one sluice closure device that seals off the sluice chamber from the environment. For example, the sluice closure device is a lockable door or cover that detachably seals off a sluice access. The sluice closure device may be realized, in particular, on the side that faces toward the tank, by a slider that enables the sluice chamber to be sealed off in an openable manner from the tank access opening.

the sluice chamber can be sealed and/or is divided into different sluice sections by means of at least one sluice gate or bulkhead, in particular for which different gas and/or pressure conditions are set. This enables access for charging and discharging to be effected particularly easily, and also at least partially independently of the tank being closed by the tank's own valve. The bulkhead secures the sluice chamber, for example, in the direction of the access opening. In the case of a sluice access that does not face toward the access opening, the sluice chamber may be sealed off in an openable manner by another or further bulkhead.

As an alternative or in addition to a cable-connected electric power supply, the inspection appliance may also be supplied with electric power without a cable, by means of a local energy store, in particular a storage battery or exchangeable energy. In such variants, the inspection appliance is preferably wireless or completely autonomous inside the tank. It is advantageously charged at a docking station of the sluice device and/or arranged for the purpose of data transfer. This docking station may be arranged, as part of a sluice device according to the invention, inside the sluice chamber and remain arranged there during the inspection. Alternatively, it may be realized on a part of the sluice device that moves into the tank.

Furthermore, the sluice device may transmit a signal into the tank for the purpose of data transmission and/or orientation of the inspection appliance, in which case it may be an optical, acoustic or generally electromagnetic signal. The inspection appliance has appropriate means for picking up this signal, which may be, for example, a 3D camera for picking up visual items of information from the signal device, and/or a sound detector for picking up signals, e.g. from a sound bar. It may also be a device for processing indoor geolocation signals, for example indoor GPS. In a simple case, the signal device may be realized by an image that can be read optically by the inspection appliance, for example a barcode. It may also be a heat source for a heat sensor arranged on the inspection appliance, or a reflector for a light emitter/receiver arranged on the inspection appliance. The signal device supports or effects the orientation of the inspection appliance in the tank.

The inspection appliance moves as described through the tank, in particular autonomously, semi-autonomously and/or under remote control, there being a corresponding control device on the inspection appliance and/or as part of the sluice device. It is understood that such a control device does not have to be fixedly connected to the sluice device but may, for example, be interfaced to it wirelessly. Preferably, however, the inspection appliance is moved through the tank in a cable-connected and remote-controlled manner, this being advantageous for data transmission and electric power supply. A semi-autonomous movement is a movement of the inspection appliance that is controlled during one phase of the work process and is effected autonomously during another phase.

In particular, following the inspection, the inspection appliance is cleaned in the sluice device, for which a sluice device according to the invention advantageously has corresponding cleaning-agent reservoirs and/or waste containers for the waste water resulting from the cleaning.

The object stated at the beginning is also achieved by a sluice device, which comprises a sluice chamber and a sluice access, and which is characterized in that the in particular mobile sluice device has means for arranging the sluice access, provided for the passing through of an inspection appliance, at an access opening of a tank. In particular, this is a flange, preferably provided with sealing means, via which the sluice device can be arranged on a complementary flange of a tank, or an access opening of a tank. For example, the flange can be equipped with quick-release fixings as described above. Other docking and sealing systems for attaching the sluice device are also conceivable, for example those in which a part of the sluice device is fitted firmly in an access opening.

Once the sluice device has been arranged in a sealing manner on the tank, the inspection appliance can be transferred into the tank through the sluice access and the access opening, after any shut-off valves in the tank have been opened and any sluice closure device that may be present has been opened. As an alternative or in addition to a flange, the sluice device may have a clamping and/or contact-pressure device, via which the part of the sluice device that has the sluice access is clamped onto and/or pressed against the tank.

Such a sluice device has the advantages described above in the explanation of the method according to the invention. In particular, such a sluice device may be realized with a tubular or cigar-shaped sluice body, or main body, which on at least one end face is provided with a corresponding means for arranging the sluice access, through which the inspection appliance is passed in the direction of the tank interior, at the access opening of the tank, and which, on its end face that is opposite this end face, may have a further sluice access, through which an inspection appliance can be inserted into a sluice device already fastened to a tank.

In particular, the sluice device is realized in such a way that it can be used to perform the method according to the invention.

The sluice device is mobile, such that it can be transported and/or moved to a next tank following completion of the inspection process, as described above. For this purpose, the inspection device may have means for fastening to a transport vehicle such as a crane or forklift and/or its own chassis having, for example, wheels or chains.

For the purpose of adaptation to the conditions present in the tank, the sluice device comprises a sensor arrangement, already described above, and/or a control arrangement, likewise described above. The sensor arrangement has at least one sensor, and preferably a plurality of sensors, in the form of pressure and/or media sensors, by means of which the items of information needed for adaptation of the sluice interior to the conditions prevailing in the tank can be acquired. By means of the control device, the parts of the control device needed for the adaptation and/or further operation of the sluice device can be operated, for which purpose the control device, which may have corresponding data processing means for this purpose, may be provided with an associated human-machine interface. Alternatively or additionally, the control of the sluice device may also be effected via a remote interface, for example a portable data processing device of the operating personnel. Programs and/or interfaces for operating the individual components such as, for example, the pump and/or valves, are stored on the computing means for controlling the sluice device.

Preferably, the sluice device has at least one pump for filling and/or emptying the sluice chamber. If different media are used, such a sluice device may also be equipped with a plurality of pumps, for example, on the one hand, for transporting liquid media and, on the other hand, for transporting gaseous media. Especially when gas is used to fill the sluice chamber, in particular an inert gas, the sluice device is preferably provided with a protective-gas or inert-gas reservoir, which can preferably be filled reversibly, i.e. any gas that has been put into the sluice chamber can also be taken back out of the sluice chamber and transferred to the reservoir. This is advantageous, in particular, if the filling of the sluice chamber with the medium present in the tank is effected by opening the access opening to the tank and the inert gas is displaced as a result.

Additionally, the control device according to the invention may have a line connection into the tank, or into a region of the access opening, which can be controlled via valves, in order to introduce the medium contained in the tank into the sluice chamber or discharge it therefrom in a controlled manner.

The carrying and/or supporting device, which is present according to a further design of the sluice device according to the invention, for transferring the inspection appliance from the sluice chamber into the tank may be arranged, for example, under the ceiling of the tubular sluice chamber or integrated into it. However, it may also be a device on the base or the side of the sluice chamber. Preferably, the sluice device may additionally have a ramp device comprising a ramp via which the inspection appliance can enter the tank. This ramp may also be telescopic and realized as part of the carrying and/or holding device. However, it may also be a further device, by means of which a ramp can be realized into the tank, beyond the access opening.

The sluice device is preferably provided with a height adjustment device, by which a height of the sluice chamber above the ground can be set. For this purpose, the chassis can be provided, for example, with telescopic supports or support feet, by means of which the sluice chamber and any other parts of the sluice device can be raised.

Preferably, the sluice device is designed to be self-propelled by means of its own drive system, such that there is no need for additional transport vehicles.

As already described above, according to one development the sluice device has at least one camera and/or at least one viewing window, which may be integrated into a wall or sluice closure device of the sluice device that closes a sluice access. Alternatively or additionally, a camera is arranged on a holding device in such a way that it can be transferred into the tank.

For the purpose of sealing the sluice chamber and possibly subdividing the sluice chamber into different compartments, the sluice device is provided with at least one bulkhead. Subdividing the sluice chamber makes it possible to realize different phases of connecting the inspection appliance and transferring it into and out of the tank. For example, in a first phase, the tightness of the connection to the tank can be checked before the medium is directed further into the part of the sluice chamber that comprises the inspection appliance.

It is understood that there is a range of possibilities for transporting different media from and into the sluice chamber in a sluice device according to the invention. In particular, for the purpose of distributing, extracting and/or filling, the sluice device has a media line for conveying the tank medium, in particular in the region of the connection piece, or flange. Alternatively or additionally, the sluice device may have a gas line having corresponding accesses into and/or out of the sluice chamber, via which in particular the inert gas can be brought into or out of the sluice chamber.

It is understood that there is a range of sensors that can be used to monitor the state of the sluice chamber in respect of filling with media. Accordingly, there is a control device by means of which the individual controllable elements of the sluice device are controlled.

Additionally, there is preferably a docking station by means of which the inspection appliance can be supplied with energy and/or via which data communication can be effected. In particular, the docking station is arranged on the carrying and holding device, such that an inspection appliance that is already in the tank can still be supplied with energy. It is understood that a docking station of the sluice device requires a suitable interfacing or interface on the inspection appliance.

The inspection appliance either has an interface that matches the docking station, or forms part of the docking station itself, via which the transmission of energy and data can be effected. The inspection appliance, together with the sluice device, may constitute an item according to the invention.

Alternatively or additionally, the inspection appliance has means for wireless data transmission. The docking station is designed, for example, for inductive charging, for which, in particular, there are corresponding coils fitted on both sides of the docking station. According to a further embodiment of the invention, as an alternative or in addition to charging via induction, an energy storage means of the inspection appliance may be charged via charging contacts that can be physically brought into contact with one another.

According to a further embodiment of the invention, the inspection appliance is designed with the docking station for the optical transmission of data. For this purpose, optical communication interfaces are provided on of the docking station as well as on the inspection appliance.

For the appropriate alignment of the inspection appliance with its interface for the docking station, environment sensors of the docking station and/or of the inspection appliance may be used, the data of which are processed by a separate computer unit or the data processing unit of the sluice device with the aim of precisely aligning the inspection appliance.

For the purpose of data transmission and/or orientation of the inspection appliance, a sluice device according to the invention has a signal device as described above, via which signals can be generated at least into the tank or in the tank itself, such that the orientation and/or return of the inspection appliance is facilitated. The inspection appliance has, in particular, means for arranging and fastening in the sluice device, for example a locking mechanism by means of which it can be fastened to a corresponding complementary part of the holding and carrying device. Furthermore, in particular, in addition to the sensors needed for inspection, it is provided with a chassis by means of which it can be moved on the tank floor and/or walls and/or ceiling. In particular, the inspection of walls and/or ceilings is effected via preferably magnetically held travelling gear elements, which can provide support and propulsion on the walls and ceilings.

A cable winding device for connecting the inspection appliance by means of a variable-length cable allows it to be supplied continuously it with energy, or allows data to be transmitted from the inspection appliance and control data to be transmitted to it, such that the inspection appliance can be moved in the tank by means of its own drive system. For this purpose, the inspection appliance is preferably provided in particular with individually controllable wheels or chains.

Finally, the object stated at the beginning is achieved by an arrangement comprising a tank, a sluice device and an inspection appliance for inspecting the tank, wherein the sluice device according to the invention is realized as described above or below, and the sluice device and the inspection appliance, which is an inspection appliance for performing non-destructive examinations, are designed to perform the method according to the invention. It is understood that the tank has a corresponding access opening for this purpose. The inspection appliance works, for example, on the basis of magnetic flux leakage (MFL), sound waves and/or electromagnetically induced sound waves (EMUS/EMAT). For the inspection of vertical walls or the upper delimitings of a tank, it preferably has magnetic holding means, in particular magnetic wheels or chains, by means of which it is held on the metallic wall/limitation of the tank.

Further advantages and details of the invention are given in the following description of the figures.

### BRIEF DESCRIPTION OF THE DRAWINGS

Reference is now made more particularly to the drawings, which illustrate the best presently known mode of carrying out the invention and wherein similar reference characters indicate the same parts throughout the views.

FIG. 1 shows a schematic representation of a device according to the invention.

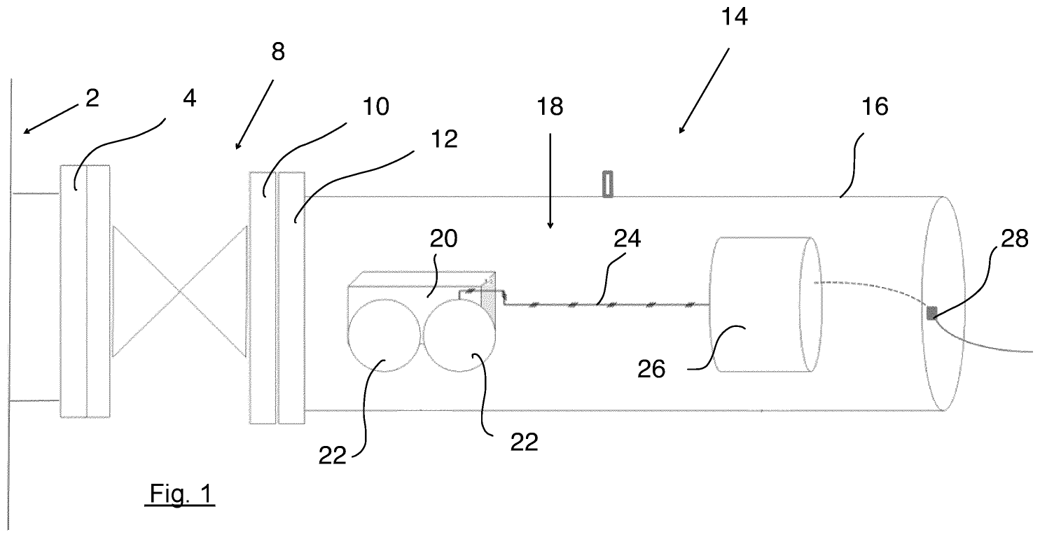

FIG. 2 shows a further item according to the invention.

FIG. 3 shows the item according to FIG. 2 in a further operating situation.

FIG. 4 shows a further item according to the invention, in a schematic representation.

FIG. 5 shows the item according to FIG. 4 in a further operating situation.

FIG. 6 shows the docking station and the inspection appliance according to FIG. 5, in a more detailed view.

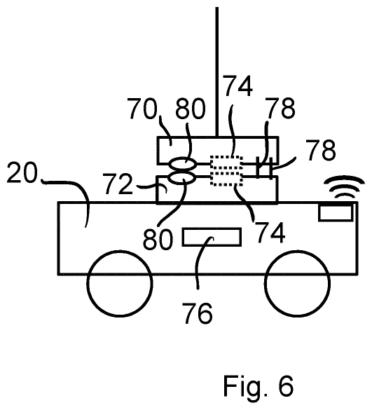

### DETAILED DESCRIPTION OF THE DRAWINGS

Individual technical features of the exemplary embodiments described below may also, in combination with the features of the independent claims and any subclaims, give rise to developments according to the invention. Where appropriate, functionally identical parts are denoted by identical reference numbers.

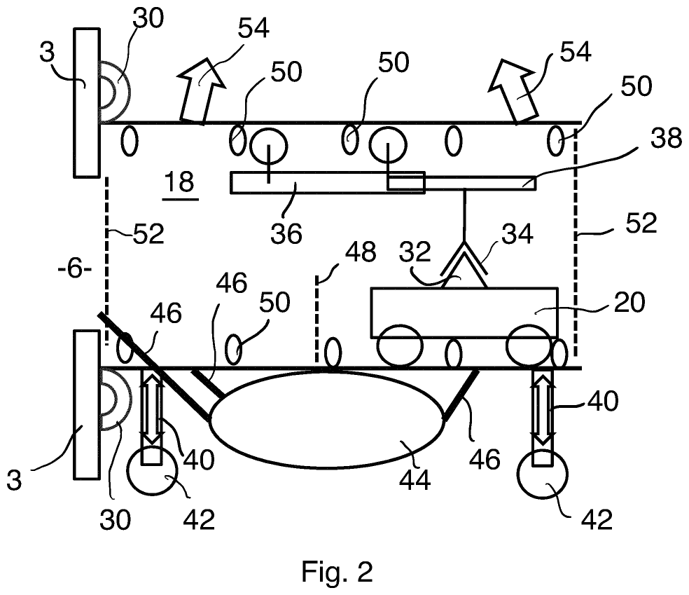

An arrangement according to the invention comprises a tank 2, which has a connection piece 4 that, together with a valve 8, realizes a closable access opening 6 (see also FIG. 2). The sluice device 14 itself is connected to a valve flange 10 by means of a suitably sealing flange 12. Alternatively, the access opening may be realized by the connection piece 4, while the valve 8 is part of the sluice device and is arranged on the rest of the sluice device in a detachable, and thus interchangeable manner, for tanks having other access opening dimensions.

The sluice device 14, which is provided with a tubular main body 16, has in its sluice chamber 18 an inspection appliance 20 that can be moved on drive wheels 22 in the tank 2. The drive wheels may have sensors for inspecting the floor and/or the wall of the tank 2. The inspection appliance 20 is supplied with energy by cable. Inspection and control data may also be transmitted via the associated energy and data cable 24. It is wound inside the sluice device, in a cable drum 26 of a cable winding device, or unwound from this cable drum 26. Inspection data are transferred to a control device of the sluice device via a port 28 at the end face and/or control data for the inspection process, including the delivery and return of the inspection appliance to/from the tank, are supplied. In addition, energy is supplied from an energy supply storage means.

According to the exemplary embodiment of the invention represented in FIG. 2, the sluice device may have a sealing arrangement 30 constructed at least partially from flexible material, by means of which it can be arranged at the access opening 6 of the tank 2 that passes through a wall 3 of the tank 2.

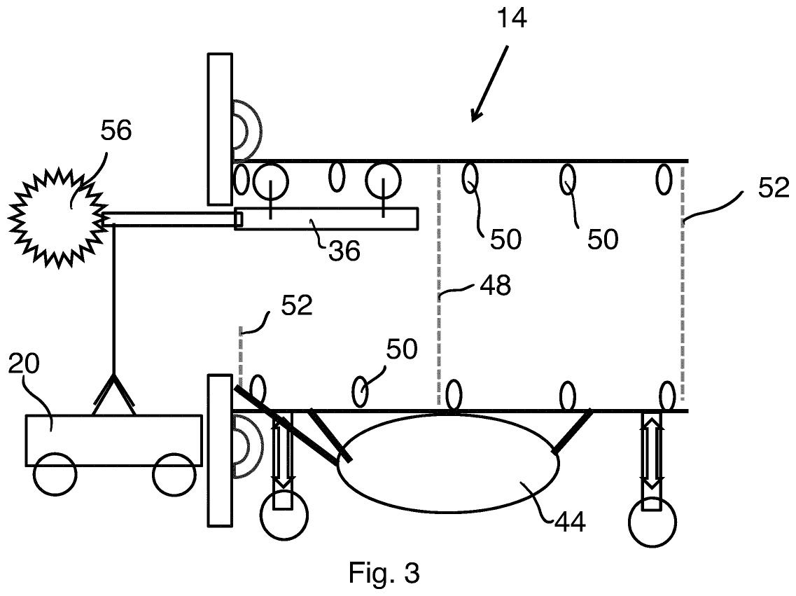

In the present case, the inspection appliance is provided with a holder 32, which is connected to a complementary holder 34 of a carrying and/or supporting device 36. The carrying and/or supporting device 36 has a telescopic arm 38, via which the inspection appliance 20 can be conveyed into the tank (see FIG. 3).

A height adjustment device has height-adjustable supports 40, which are telescopic and have sluice drive wheels 42 at their end that faces toward the ground. This allows the sluice device to be adjusted in height and thus adapted to different heights of access openings of the tank 2. The sluice device 14 can be moved to the access opening by means of the sluice drive wheels 42, each of which has its own electric-motor drive unit.

A pump and supply unit 44 comprises various pumps for filling and emptying the sluice chamber, as well as a plurality of media lines 46, through which, on the one hand, two regions of the sluice chamber separated by a bulkhead 48, and also the region facing toward the access opening 6 (in FIG. 2 to the left of a left-side sluice closure device 52) can be filled and emptied. A right-side sluice closure device 52 seals the sluice chamber 18 from the environment during operation (FIGS. 2 and 3).

There are also gas lines, which have access or emptying ports 50 at various locations on the sluice chamber or its wall. These may also be the vent openings, described above. Arrows 54 indicate means for arranging the sluice device on a lifting device.

Furthermore, arranged on the carrying and/or supporting device 36 there is a signal device, which is designed to output a signal 56 and which serves to orientate the inspection appliance 20, which preferably moves and measures autonomously in the tank.

The holders 32 and 34 form a docking station, via which not only an energy supply to the inspection appliance 20 may be effected, but via which data may also be transferred.

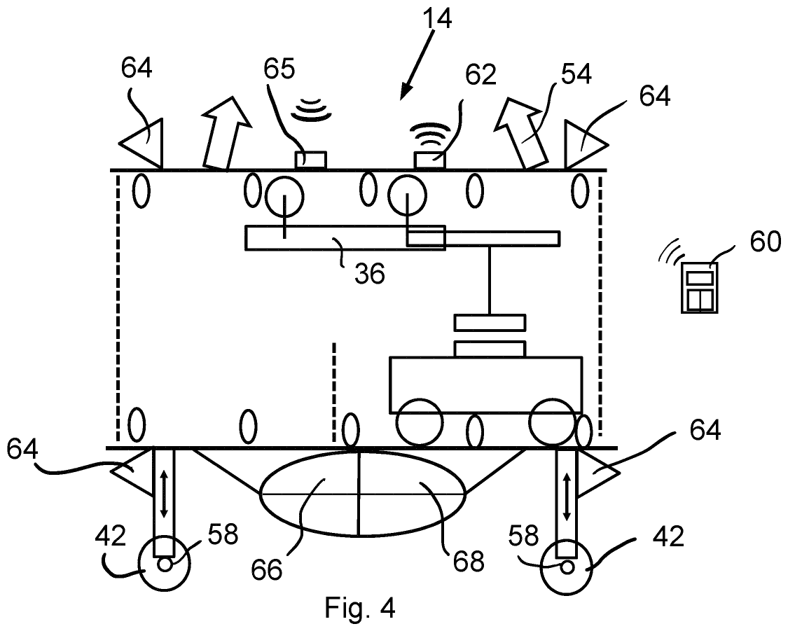

In a further embodiment according to the invention as shown in FIG. 4, the sluice device, which is self-propelled by means of its own drive system, comprises a chassis of the drive system having electric wheel hub motors 58, by means of which the sluice drive wheels 42 can travel on a road-like or flat surface. The wheels 42 of the drive system may be actuated to rotate against each other or with each other to cause the sluice device 14 to rotate about a vertical axis. Alternatively, wheels 42 that can be rotated about a vertical axis by means of further motors and corresponding joints may also be used.

The sluice device additionally has a wirelessly connected remote control 60, by means of which the two drive wheels 42 on each side can be moved forward or backward simultaneously. The control signals from the remote control 60 reach the computer unit 66 via an interface 62, where they are converted into corresponding signals for the wheel hub motors 58.

The computer unit is preferably configured with its software such that the sluice device can drive to a tank independently by means of the data from its environment sensors 64 and a receiver 65 of a system for determining the geo-position (e.g. GPS), and by means of the drive system. For this purpose, the position of a lateral access opening is stored in a memory of the computer unit 66.

An energy storage means 68 supplies the sluice device and any associated inspection appliance with energy.

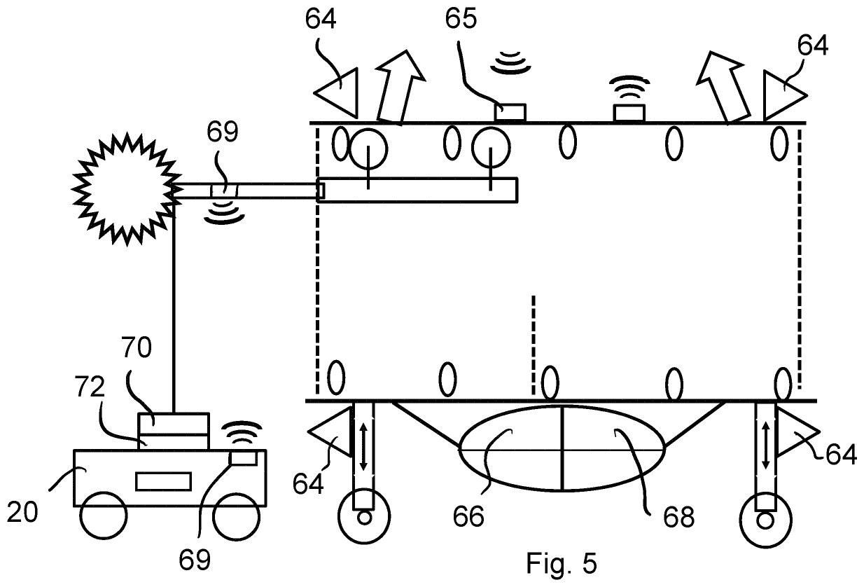

Like the sluice device, the inspection appliance according to FIG. 5 has means 69 for wireless data transmission. In particular, the means 69 for wireless data transmission are arranged in the telescopic part of the carrying and/or supporting device 36 that can be inserted into the tank, such that good data transmission is ensured during an autonomous inspection of the tank.

The inspection appliance 20 additionally comprises an interface 72 suitable for the docking station 70 of the sluice device 14.

Like the interface 72 of the inspection device 20, the docking station 70 is designed for inductive charging by means of corresponding coils 74. In addition or as an alternative to charging via induction, charging of an energy storage means 76 of the inspection appliance 20 is effected via physical contact by means of charging contacts 78.

The inspection appliance 20 is also designed with the docking station 70 for the optical transmission of data. For this purpose, optical communication interfaces 80 are provided on the docking station 70 and on the inspection appliance 20.

1. A method for inspecting a tank for fluid media with an inspection appliance that records measurement data on the inside of the tank on a floor, a wall and/or any upper delimitation of the tank that is present, the method comprising the steps of:
connecting a sluice device to the tank;
adapting a sluice chamber of the sluice device to conditions present in the tank;
inserting the inspection appliance into the tank from the sluice chamber of the sluice device through a sluice access in the sluice device and through an access opening in the tank,
measuring and recording data by the inspection appliance;
transferring the inspection appliance back into the sluice device.

2. The method as claimed in claim 1, wherein the sluice device, which has a sealing arrangement on at least one side, is initially arranged close to the tank in such a way that the access opening can be reached from the sluice chamber.

3. The method as claimed in 2, wherein the sluice device, which can be closed by at least one sluice closure device, is arranged at an access opening of the tank.

4. The method as claimed in claim 1, wherein the inspection appliance is inserted into the sluice device in advance and/or removed subsequently.

5. The method as claimed in claim 1, wherein, for the purpose of adaptation to the conditions present in the tank, data from at least one sensor arrangement are acquired.

6. The method as claimed in claim 1, wherein, for the purpose of adaptation to the conditions present in the tank, valves are controlled by a control device of the sluice device.

7. The method as claimed in claim 1, wherein, for the purpose of adaptation to the conditions present in the tank, the sluice chamber is flooded with an inert gas and/or the sluice chamber is filled with the medium stored in the tank during and/or before opening of the access opening.

8. The method as claimed in claim 1, wherein the inspection appliance is transferred from the sluice chamber, through the access opening, into the tank by a carrying and/or supporting device of the sluice device.

9. The method as claimed in claim 1, wherein, for the purpose of arranging the sluice device at the access opening, the sluice device is adjusted, by a height adjustment device, with respect to the height above the ground.

10. The method as claimed in claim 1, wherein the inspection appliance is checked by at least one camera and/or by at least one viewing window.

11. The method as claimed in claim 1, wherein the sluice device is moved to the place of use by its own drive system.

12. The method as claimed in claim 1, wherein the sluice chamber is divided into different sluice sections by at least one bulkhead.

13. The method as claimed in claim 1, wherein the inspection appliance is charged at a docking station of the sluice device and/or arranged for the purpose of data transfer.

14. The method as claimed in claim 1, wherein a signal is transmitted into the tank from the sluice device.

15. The method as claimed in claim 1, wherein the inspection appliance moves through the tank autonomously and/or under remote control.

16. The method as claimed in claim 1, wherein, following the inspection, the inspection appliance is cleaned in the sluice device.

17. A sluice device comprising:
at least one sluice chamber and a sluice access,
means for arranging the sluice access, wherein the sluice access provides an opening for passing an inspection appliance from the sluice chamber, through an access opening of a tank.

18. The sluice device as claimed in claim 17, further including at least one pump for filling and/or emptying the sluice chamber.

19. The sluice device as claimed in claim 17, further comprising an inert-gas reservoir, a waste container and/or a cleaning-agent reservoir.

20. The sluice device as claimed in claim 17, further comprising a carrying and/or supporting device for transferring the inspection appliance from the sluice chamber into the tank.

21. The sluice device as claimed in claim 17, wherein the sluice device comprises a height adjustment device.

22. The sluice device as claimed in claim 17, wherein the sluice device is self-propelled by means of its own drive system.

23. The sluice device as claimed in claim 17, wherein the sluice device comprises at least one camera and/or at least one viewing window.

24. The sluice device as claimed in claim 17, wherein the sluice device has at least one bulkhead and/or at least one sluice closure device.

25. The sluice device as claimed in claim 17, wherein the sluice device has a further sluice access arranged at the opposite end of the sluice device.

26. The sluice device as claimed in claim 17, further comprising at least one media line for conveying the tank medium in the sluice device.

27. The sluice device as claimed in claim 17, further comprising at least one gas line.

28. The sluice device as claimed in claim 17, further comprising at least one docking station.

29. The sluice device as claimed in claim 17, further comprising a signal device for the purpose of data transmission and/or orientation.

30. The sluice device as claimed in claim 17, further comprising a cable winding device for connecting the inspection appliance by a variable-length cable.

31. The sluice device as claimed in claim 17, further comprising a ramp device comprising a ramp via which the inspection appliance can enter the tank.

32. The sluice device as claimed in claim 17, further comprising a sensor arrangement for the purpose of adaptation to the conditions present in the tank and/or for monitoring the sluice chamber.

33. The sluice device as claimed in claim 17, further comprising a control device for the purpose of adaptation to the conditions present in the tank.

34. (canceled)
